(19) United States
(12) Patent Application Publication
(10) Pub. No.: US 2015/0019453 A1
(43) Pub. Date: Jan. 15, 2015

(54) SYSTEM FOR AIDING IN THE APPLICATION TO MULTIPLE COLLEGES

(71) Applicant: Felicia Eugenia Mebane, Carrboro, NC (US)

(72) Inventor: Felicia Eugenia Mebane, Carrboro, NC (US)

(21) Appl. No.: 14/326,922

(22) Filed: Jul. 9, 2014

Related U.S. Application Data
(60) Provisional application No. 61/844,852, filed on Jul. 10, 2013.

(51) Int. Cl. G06Q 50/20; G06Q 10/00

(52) U.S. Cl. CPC G06Q 50/205; G06Q 10/00
USPC 705/327

(57) ABSTRACT

A coordinated college application system provides a means for finding and collecting information and applying to colleges from a single location. Information is easily shared for use in multiple colleges.

This application claims priority of U.S. provisional application No. 61/844,852 filed on Jul. 10, 2013 and is incorporated in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to college applications. In particular it relates to a system and method for coordinating the college application process, understanding the college application process, paying for college, and applying for admission to one or more colleges.

2. Description of Related Art

The process of a student applying to the various colleges of their choice, undergraduate or graduate, has become an increasingly more complicated, competitive and confusing process over the years. Students are beginning the process of deciding on schools earlier and earlier, with students starting the process as early as their freshman year in high school for admission to an undergraduate college program.

The college application process involves understanding the application process, understanding what each college offers and costs, selecting colleges to apply to, meeting deadlines, applying for loans or scholarships, sending grades to the colleges, collecting recommendations, taking tests, getting advice on colleges, filling out and sending applications to colleges, understanding each college's requirements, and understanding each application cost. On top of that, the complicated process raises many questions because of confusing or conflicting information that different colleges give to potential applicants. Not only is there an ever increasing amount of paper or notes the student accumulates, but with the advent of the internet, there are a myriad of web-sites that the student must visit in order to collect/leave information.

There are many sources for assisting the student in the college application process including: high school guidance counselors/college advisors, private consultants, books, test preparation services, recommendation sites, writing assistance, financial aid advice, and the like. There is nothing, however, that totally coordinates the whole process in a manner that deals with the paperwork, internet issues and accumulation of data in one place.

### BRIEF SUMMARY OF THE INVENTION

The present invention relates to a system and method, for a student applying to one or more colleges, to coordinate the entire college application process in one place. The invention relates to a web-site which provides: deadline tracking, college information, advice, application coordination, web-site coordination, and the like; thus allowing the student to keep an incredible amount of information.

Among other tasks that cannot be accomplished without the present invention, include: assist users in the decision-making process, thus improving the decision quality, allow users to change content organization, provide tools to help users manipulate content collection, input and the like, link users directly to sources of content, help users generate, store documents and the like.

Accordingly, in one embodiment the invention relates to a web-site hosted on at least one computer and in communication with a computer network, which provides assistance and coordination in the entire process of a student applying to one or more degree programs comprising:
a) a storage module;
b) an input module;
c) a college information module;
d) a deadline module;
e) a college application module;
f) an external resource module;
g) a financial aid module; and
h) a guidance module.

In another embodiment the invention relates to a method for the computerized application of a student to one or more college degree programs comprising:
a) the student accessing a web-site on a computer network via one or more student computers, the web-site comprising:
   i. a storage module;
   ii. an input module;
   iii. a college information module;
   iv. a deadline module;
   v. a college application module;
   vi. an external resource module;
   vii. a financial aid module; and
   viii. a guidance module,
b) the student accessing the colleges to which are to be applied via the college information module;
c) the student accessing the remaining modules, as needed, to collect information and data for applying to the accessed colleges;
d) the student storing information on the storage module;
e) the student using the stored information to fill out an application to the colleges; and
f) the student using the application to apply to the colleges.

In yet another embodiment the invention relates to a system for the computerized application of a student to one or more college degree programs comprising:
a) a computer-readable medium that stores instructions executable by one or more processors to perform a method for a student to apply to the one or more college degree programs comprising:
   i. a storage module;
   ii. an input module;
   iii. a college information module;
   iv. a deadline module;
   v. a college application module;
   vi. an external resource module;
   vii. a financial aid module; and
   viii. a guidance module,
b) one or more servers for executing the computer-readable medium instructions, the one or more servers connected to a computer network and having a computer network interface;
c) at least one student connected to the one or more servers over the computer network via the network interface;
d) the student storing information on the storage module;
e) the student using the stored information to fill out an application to the colleges; and
f) the student using the application to apply to the colleges.

### BRIEF DESCRIPTION OF THE DRAWINGS

FIG. 1 is a relationship drawing of the system of the present invention.

FIG. 2 is a flow chart of an embodiment of the method of the present invention.

### DETAILED DESCRIPTION OF THE INVENTION

While this invention is susceptible to embodiment in many different forms, there is shown in the drawings, and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these, or their equivalent, in view of the disclosure herein, and use of the term “means” is not intended to be limiting.

As used herein the term “computer or student computer” refers to a digital device that is programmable and designed to automatically carry out a sequence of mathematical or logical operations. More specifically, it is capable of running or implementing the software that practices the present inventive method. The computer may be a personal computer (i.e. a laptop or desktop home computer); a server; or a mobile device, such as a tablet (e.g. an iPad®), a smart phone (e.g. an iPhone®) or similar devices. The term computer also refers to two or more computers that are networked together. One of ordinary skill in the art would understand what is meant by network. The following are examples of networks: PAN, LAN, WAN, WLAN, VLAN, SAN, MAN, VPN, backbone networks, and private enterprise networks. Similarly, the term computer also refers to two or more computers connected via the Internet, i.e. what has become commonly known as World Wide Web.

As used herein the term “web-site” refers to a set of related web pages served from a single web domain. A web-site is hosted on at least one web server computer, accessible via a computer network such as the Internet or a private local area network through an Internet address known as a Uniform Resource Locator (URL). All publicly accessible web-sites collectively constitute the World Wide Web.

A webpage is a document, typically written in plain text interspersed with formatting instructions of Hypertext Markup Language (HTML, XHTML). A webpage may incorporate elements from other web-sites with suitable markup anchors.

Webpages are accessed and transported with the Hypertext Transfer Protocol (HTTP), which may optionally employ encryption (HTTP Secure, HTTPS) to provide security and privacy for the user of the webpage content. The user's application, often a web browser, renders the page content according to its HTML markup instructions onto a display terminal or Graphic User Interface (GUI).

The pages of a web-site can usually be accessed from a simple Uniform Resource Locator (URL) called the web address. The URLs of the pages organize them into a hierarchy, although hyperlinking between them conveys the reader's perceived site structure and guides the reader's navigation of the site, which generally includes a home page with most of the links to the site's web content, and a supplementary about, contact and link page. The present invention web-site requires a subscription to access some or all of the content, data, and the like.

As used herein the term “computer-readable medium” refers to any electronic storage medium and may include both volatile and nonvolatile, removable and non-removable media implemented in any method or technology for storage of information such as computer readable instructions, data and data structures, applications or components or other information. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer.

As used herein the terms “college and college degree programs” refer to any program being applied to at a college, university, technical college, community college, trade school or other program at an institution of higher learning, including: associate's, bachelor's, master's and doctorate degrees. It also can include certificate, training, and enrichment programs and the like.

As used herein the term “student” refers to a person who is applying to a college to attend a college degree program and needs to coordinate the whole process start-to-finish. “Student” refers to someone who is applying to virtually any program beyond high school that requires the submission of an application. This would apply to a student applying to college for the first time or to a student applying for an additional undergraduate degree or to a post-baccalaureate program.

In the practice of the present invention, the web-site coordinates and assists a student applying to one or more college degree programs by offering a combination of college search tools, storage of application information, a standard module to coordinate input, deadline tracking, external resource coordination, financial aid, and an independent guidance module. The present invention is not just a collection of items, but a complete tool, which aids in decision-making, improves the quality of the decision, interlinks information for use across different colleges, and the like. The present invention has a number of modules that together are more than the sum of the individual parts. In one embodiment the system allows users of the system to obtain information from other users of the system, which allows the user to accomplish more than if doing the work alone. The modules that follow not only store and organize existing information in a way not previously accomplished, let alone in a system where a student can collect and use the entire application process from one location, it also adds new features previously not available. Specific examples will be outlined in more detail in the various modules. It is clear that the module concept can be such that modules can be separated into further modules and that some features of a module can exist in more than one module or be in one module and in one version and in another module in the next. However, one skilled in the art, upon reading the specification herein, would understand the totality of the invention as claimed and intended. Each module is part of a single web-site so that information in multiple modules can be utilized at the same time such that the entire application process becomes more seamless. Modules could also communicate with one another and share digital information to further streamline the process.

As used herein the term “storage module” refers to space on the web-site via computer-readable medium in the server or other computer location, such as hard drive, digital memory and the like, where documents and other information of the student can be collected in the application process. The information can be a single site or can have subdirectories, or the like, to organize and aid the student in finding the information stored. So for example, copies of transcripts, college catalogs, blank applications, written information for entering into an application, personal financial data, contact information, notes, maps, cost data, rankings, calendars, links/URLS (to webpages, social media, forums, and the like), test results, portfolios, resumes, essays, meeting schedules, correspondence, funding data, and the like. The information can be written documents, PDF-like documents, photographs, lists, important web-sites, and the like. In general, once a digitally savable piece of information is obtained, it can be saved in the storage module.

As used herein the term “input module” refers to a place for the student to sign-up to the web-site of the present invention. Upon doing so, they can then enter information about themselves, pay for use of the web-site, obtain passwords, contact the web-site administration, search the web-site, and the like. This module may interact with other modules and place items in other modules as the input module decides.

As used herein the term “college information module” refers to a place where the student can look up information about a college to which the student is desirous of applying. The module may have all the information stored in a database on a computer which is accessed by the student when accessing the module. By having all the college information in one place, the student does not have to go to multiple web-sites for each college, but rather can obtain admissions information, location, the actual college application, financial aid information, housing information, as well as facts about the college that may be of interest to the student or required for admission. The module may organize the search through such a database. In this module a student could look for colleges based on location, size, degrees available, student body characteristics, sports, student housing availability or any other number of things offered or available. In addition, it may list colleges that the student was not even aware of, making the application process more complete and much less time-consuming and cluttered. For example, when searching for colleges for an engineering degree, the student may find colleges that they were either not aware had an engineering degree, including colleges that may have newly added such a degree. The college information module may also provide web-site information for the student directly accessing the college web-site by providing a complete list of colleges (even if the student is not considering applying to a particular college). By providing information about all colleges, it greatly improves the collection of information and provides information that the student could not have practically achieved if doing things manually. In practice, a student would visit this module and browse the colleges or search for ones they desire and collect information about the colleges. Information could be stored in the storage module or temporarily looked at in the college information module.

As used herein the term “deadline module” refers to a tracking system for providing deadline monitoring of any deadlines for the college application process, such as deadlines for submission and test taking, college application deadlines, scholarship application deadlines, and the like. It could also be used to enter student dates, such as for studying, to work on applications, to tour a campus, to meet with a reference, and the like. It would provide them in one place on the web-site to provide a reminder of the various deadlines which is standardized and may vary among various colleges. The module can provide an online calendar with the various dates either inputted or placed by the system based on standardization or because the system has been programed for certain dates, such as application deadlines of certain colleges. The system can then send reminders or be used to generate to do lists for the various tasks either imposed or arbitrary in nature.

As used herein the term “college application module” is a module that contains all of the application information required for each college being considered or applied to. It would allow the user to fill in application components in a digital format and hold all the information, which may be also moved from the storage module and directly from outside sources. The module would allow the user to create a specific application for each college to which the user plans to apply. The module would then aid in sending the application information to the college's application system or to an intermediate 3^{rd} party application system, such as AMCAS and SOPHAS. In one embodiment the application information is sent directly from the web-site to the college application system either digitally or materials can be printed in order to send paper copies to the college.

As used herein the term “external resource module” refers to a place on the web-site where the user can go to find resources not on the web-site for use in the college application process. Lists (including web-sites, phones addresses, and the like) of counselors, financial aid, test aids, off campus housing, job opportunities, religious institutions, mass transit, attendance costs, social activities and the like, will be found and organized to further aid the student applicant. This module can also link the student to web-sites, blogs, forums, and the like, that provide advice and guidance on the admissions process.

As used herein the term “financial aid module” refers to a module that aids the student applicant in searching for and obtaining financial aid. The module will contain a database, stored on the server or other computer, of places to obtain financial aid (e.g. loans, scholarships, grants, gifts, and the like), as well as the amounts, the criteria for applying, and the like. The module would allow the user to search and organize information. The module would aid in sending financial aid application information to colleges and funding institutions. In one embodiment, it includes the ability to fill out a financial aid application on the web-site and apply for financial aid through the web-site, rather than an external process, which takes further time and effort.

As used herein the term “guidance module” refers to providing the student advice on the college application process. This can be in the form of short tips, essays or other writings giving advice to smooth out and simplify the process, information about how to use the present invention web-site or anything relating to the process of applying to college which may be of interest to the student. In one embodiment it relates to a live person being available over the web, or through the web offline, to personally offer one-on-one counseling in the process of application. In one embodiment by having an online chat function, the user can immediately, at the point of a problem, get help and not have to shut down the application process waiting for an appointment. In one embodiment, groups of students may attend online webinars or sessions that would also be available in an archive.

As used herein the term “references module” refers to a place where, in the process of applying to a college degree program, the user can find or store information concerning people who are references. Typically, college applications require the name, contact information, and in some cases, contact directly from the reference. This module can be used to coordinate those people by keeping lists and contact information, letters from references, or other data or information in the process. In one embodiment, the student can contact the reference directly from the web-site.

As used herein the term “test module” refers to a module that tracks aspects of the student taking entrance exams or other tests connected with the application process. Standardized tests, like the LSAT, GMAT, GRE and the like are included. The module would hold study material, application material, and all information related to taking a test that will be submitted to a college during the application process. The student could then collect the information on colleges to which the test results need to be sent, have a place for recording the results themselves, or holding documents or information for later attachment to the college application, and have a place to go to get tips, study aids, testing schedules and locations, new testing features, average scores, and the like.

As used herein the term “self-created module” refers to a module which the student can create for a personalized module that doesn't exist on the site but the student determines is necessary, perhaps a photograph collection or something that a particular school wants that is not a standard requirement. In one embodiment, this module includes specific features or subsets of existing modules.

As used herein the term “grades module” refers to a module which not only stores grades from previous schools but allows manipulation of the presentation of the grades to highlight particular grades. For example, in applying to a chemistry graduate program the grades for organic chemistry and physical chemistry could be highlighted. Highlighting can be done by isolating the grades, calculating a GPA for just certain classes (e.g. classes in their major), and presenting the grades in any particular way.

As used herein the term “recruitment module” refers to the fact that many schools hold recruitment fairs, or other events, for the purpose of getting desirable students to apply to their college. This module, concerning attending a recruitment event, can collect information about such events, give reminders, schedule appointments, schedule deadlines, and the like.

As used herein the term “extracurricular activities module” refers to a module that tracks the availability of extra-curricular activities such as sports, clubs, activities, and charities. This module also provides information concerning how to apply for activities, and it allows one to search colleges for desirable activities. While this could be part of the college module, a separate module will allow for storing this information separately for easier management and better organization.

So, for example, in one embodiment a high school sophomore is considering different colleges to attend upon graduation. She has not decided on a major, though she is considering eventually attending law school or nursing school. To qualify for those advanced degrees, she might major in political science or biology. As she attends high school and talks to friends, family, and counselors, she uses the college information, financial aid, and guidance modules to collect information and takes notes about these majors, the colleges that provide the best training in them, and how to pay for college. She also relies on external resource and guidance modules to make sure she understands the admissions process and qualifications for her potential majors. She uses the deadline module to keep track of important dates. To narrow her choices, she uses the recruitment module to plan trips to campuses or online recruitment sessions. During her junior year, she uses the test module to plan and prepare for taking the SAT. She takes the SAT and uses the test module to keep track of her scores, the grades module to keep track of her grades and transcript, and the extracurricular module to keep track of other accomplishments. She uses all of those modules to keep track of how to report that information to the colleges. She also creates a self-created module that only lists key facts for each college that will help her make a decision. In the early part of her senior year, she starts work on her essay and resume, which she stores in the invention, and uses the references module to contact and confirm her references. She uses the information in the invention to narrow her top choices to five colleges. She then uses the application module to gather the specific information for each application (including application costs) to eventually submit the applications. No other web-site allows her to connect to, organize, and use all of this information in one place. Not just lists of information, the invention makes connections between modules that help her manage the process for multiple applications to different colleges and programs. The invention also allows her to store the information so that when she applies to nursing school, she can build the new application starting with information from the previous process, such as financial aid information, references, and the like. She can even add information as she completes her college degree. So for example a student wishing to apply to law school would sign up on the web-site of the present invention. They would track their LSAT test taking process as well as the test results for the LSAT. If the student were, for example, at the same time applying to other programs such as nursing, those tests could also be focused on in the test module. The module would aid the student in preparing and taking the test as well as applying for the test. The college module would help the student review and choose which college had the right program for their desired major and provide an application, as well as information about deciding about attending and what information will need to be provided during the application process. The rest of the modules can be utilized to do the various processes of application as noted above in one place and in a way not possible without the present invention. So more than a collection of items, it can provide services not otherwise available and allow digital manipulation of the items right down to the application process, which can be sent from the web-site. This is true even when there are more than one college and or more than one degree type program being applied for at the same time.

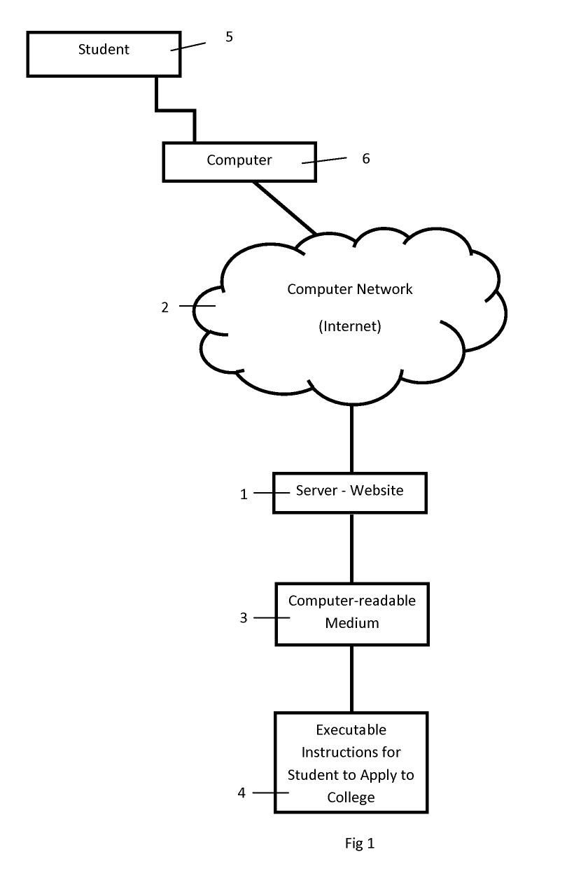

Now referring to the drawings, FIG. 1 is a relationship chart of the various parts of the invention web-site and system. A web-site is hosted on a server computer 1 and is in communication with a computer network (e.g. internet) 2. The server has computer-readable medium 3, which contains the various modules (listed elsewhere) in the form of executable instructions 4 for the student 5 using a computer 6 applicant to interact with over the internet 2 and coordinate the student to apply to one or more colleges.

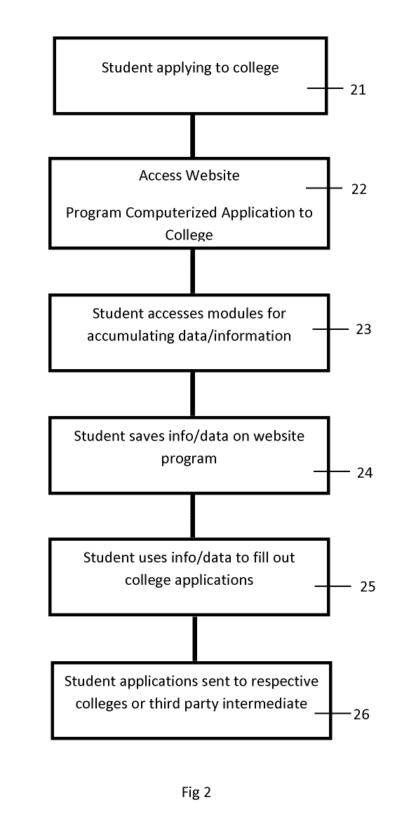

FIG. 2 is a flow chart of the method of the present invention. A student, who is applying to one or more college 21, accesses a web-site having a program for computerized application to one or more colleges 22, as described above. The student accesses one or more modules for accumulating, reviewing using data and information 23. The student saves selected information and data on the web-site program 24. The student uses information and data to apply to colleges selected in the modules by filling out applications on the web-site 25. The college application information is then sent to respective colleges 26 or, in one embodiment, a third party intermediate.

Those skilled in the art, to which the present invention pertains, may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like, apparent to those skilled in the art, still fall within the scope of the invention as claimed by the applicant.

What is claimed is:

1. A web-site hosted on at least one computer and in communication with a computer network, which provides assistance and coordination in the entire process of a student applying to one or more degree programs, comprising:
a) a storage module;
b) an input module;
c) a college information module;
d) a deadline module;
e) a college application module;
f) an external resource module;
g) a financial aid module; and
h) a guidance module.

2. A web-site according to claim 1 wherein a student accesses the web-site and applies to one or more college degree program using the web-site.

3. A method for the computerized application of a student to one or more college degree programs comprising:
a) the student accessing a web-site on a computer network via one or more student computers the web-site comprising:
i. a storage module;
ii. an input module;
iii. a college information module;
iv. a deadline module;
v. a college application module;
vi. an external resource module;
vii. a financial aid module; and
viii. a guidance module,
b) the student accessing the colleges to which are to be applied on the college information module;
c) the student accessing the remaining modules as needed to collect information and data for applying to the accessed colleges;
d) the student storing information on the storage module;
e) the student using the stored information to fill out an application to the colleges; and
f) the student using the application to apply to the colleges.

4. A system for the computerized application of a student to one or more college degree programs comprising:
a) a computer-readable medium that stores instructions executable by one or more processors to perform a method for a student to apply to the one or more college degree programs comprising:
i. a storage module;
ii. an input module;
iii. a college information module;
iv. a deadline module;
v. a college application module;
vi. an external resource module;
vii. a financial aid module; and
viii. a guidance module,
b) one or more servers for executing the computer-readable medium instructions, the one or more servers connected to a computer network and having a computer network interface;
c) at least one student connected to the one or more servers over the computer network via the network interface;
d) the student storing information on the storage module;
e) the student using the stored information to fill out an application to the colleges; and
f) the student using the application to apply to the colleges.

5. The system according to claim 4 wherein the interface is web-site.
